(19) United States
(12) Patent Application Publication
(10) Pub. No.: US 2018/0245279 A1
(43) Pub. Date: Aug. 30, 2018

(54) NANO-BORON FOR TEXTILES

(71) Applicant: OZYEGIN UNIVERSITESI, Istanbul (TR)

(72) Inventor: Gul Bahar BASIM DOGAN, Istanbul (TR)

(21) Appl. No.: 15/762,477

(22) PCT Filed: Jun. 7, 2016
(86) PCT No.: PCT/TR2016/050169

§ 371 Date: Mar. 22, 2018

(51) Int. Cl. D06M 11/81; D06M 11/77; D06M 13/188; D06M 11/46; A01N 25/04; A01N 59/14; C09D 5/14; C09D 7/40; C09D 7/61; C09D 7/62

(52) U.S. Cl. CPC D06M 11/81; D06M 11/77; D06M 13/188; D06M 11/46; A01N 25/04; D06M 2101/32; C09D 5/14; C09D 7/67; C09D 7/61; C09D 7/62; C09D 7/69; A01N 59/14

(57) ABSTRACT

The present disclosure relates to textile coatings, and to nanometer sized particles of boron in solution used for textile coatings. In one embodiment, a nano-boron textile coating is comprised of a solution including silicon, a dispersant, a softener, and acetic acid mixed in water; and a plurality of nano-boron particles dispersed in the solution. A textile with an applied nano-boron textile coating, and a process for preparing and applying a textile coating are also disclosed.

### TECHNICAL FIELD

The present disclosure relates to textile coatings, and in particular to nanometer sized particles of boron and/or its compounds in solution used for textile coatings.

### BACKGROUND

Textiles have long been recognized as being prone to growth of microorganisms, such as bacteria and fungi. These microorganisms may exist in the environment even at unfavorable conditions and can quickly grow when the suitable moisture, nutrient and temperature conditions are available. The growth of microbes and bacteria on textiles during their use or storage not only degrades the performance of the textile itself but also negatively affects public health.

Synthetic fibers, due to their high hydrophobic characteristic, are generally more resistant to attacks by microorganisms than natural fibers. However, natural fibers or a combination of natural fibers with synthetic fibers are often preferred by the consumer and/or manufacturer.

The detrimental effects caused by microbes can be controlled by applying a durable antimicrobial finish to the textiles by using broad-spectrum biocides or by incorporating the biocide into synthetic fibers during extrusion. However, while antimicrobial finished textiles provide the benefits of hygiene, odor control and protection of the fabric from microbial attacks, potential toxic breakdown products of the biocides are a concern environmentally as well as for the consumer or household. Furthermore, most biocides used on commercial textiles can develop bacterial resistance to the substances, which can lead to increased resistance to certain antibiotics in clinical use. Antibacterial agents containing natural and inorganic substances have been researched but only a few of them are commercially available. Metals and metal oxide nanoparticles, including copper and silver have also been investigated.

One of the most critical uses of antibacterial textiles applies to medical applications. Hospital-acquired infections, known as nosocomial infections, may cause epidemic-like conditions, such as one in every ten patients being affected. The main route of infection is from the infected patient to healthcare professionals to an uninfected patient or visitor through inadvertent contacts with the surfaces of hands, furniture, walls, bed linens and upholstery. Death from such infections is also high due to the ineffectiveness of the common broad-spectrum antibiotics including beta lactum antibiotics. These infections are mostly caused by a limited number of bacterial pathogens, such as methicillin/vancomycin-resistant Staphylococcus aureus (MRSA/VRSA), methicillin-resistant S. epidermidis, Escherichia coli, C. difficile, VRE, Acitenobacter, and Pseudomonas aeruginosa, although MRSA and E. Coli have been the most studied strains. Accordingly, there is a need to either prevent bacterial attachment to these surfaces or in situ killing of the attached microbes. There are several commercially available antimicrobials such as triclosan, ammonium compounds, zinc pyrithione and silver. Yet these compounds are typically only effective on either gram-negative or gram-positive bacteria and not effective on both types of bacteria.

Titanium oxide (also referred to as titania) is a known photocatalytic material and has been studied for its photocatalytic properties extensively in preventing growth of bacteria and microbes. However, commonly utilized titania particles are only effective within UV radiation to visible light ranges.

Thus, there is still a need in the art for a readily available and enhanced textile coating to provide antibacterial, antimicrobial, stain resistance, and/or photocatalytic properties, and an efficient process for preparing such a textile coating, particularly one that can be photocatalytically active within the visible light range.

### BRIEF DESCRIPTION

The present disclosure provides a novel and high performance textile functional coating composed of nanoparticles of boron (including in some embodiments substantially pure boron alone or a combination of substantially pure boron and boron compounds, such as boron oxides, nitrides, carbonates, and/or the like), which is referred to hereinafter as “nano-boron”. The textile coating of the present disclosure eliminates or reduces the above-mentioned shortcomings of prior textile coatings and provides an enhanced antimicrobial and/or photocatalytic activity or property, which enables improved bacterial/fungal and stain resistance.

In one embodiment, a nano-boron textile coating is comprised of: a solution including silicon, softener, a dispersant, and acetic acid, mixed in water; and nano-boron particles dispersed in the solution. In an example, the solution may include 10-15 g/l silicon, 5-10 g/l non-ionic softener, 0.1-1.0 g/l dispersant, and 0.1-1.0 g/l acetic acid, mixed in deionized water, at a total weight percentage of 1.0-4.0 wt % in water at a pH of 3.5. In an example, 0.001-0.2 wt % of nano-boron particles are dispersed in the solution. In another example, 0.001-2 wt % of nano-boron particles are dispersed in the solution to provide for even more anti-bacterial effectiveness. In one example, the silicon, softener, and dispersant are Setasif®, Serisoft®, and Ekoline® textile finishing chemicals, respectively.

In another embodiment, a nano-boron textile coating is comprised of: a hydrophobic solution including surface modified silicon oxide nanoparticles having an average particle size between 2.7 μm and 3.0 μm, non-ionic softener, a dispersant, and acetic acid mixed in water, the solution having a weight percentage in the nano-boron textile coating between 2.7 wt % and 3.0 wt %; a plurality of nano-boron particles dispersed in the solution, the nano-boron particles having an average particle size between 50 nm and 100 nm and having a weight percentage in the nano-boron textile coating between 0.001 wt % and 0.2 wt %; and a plurality of anatase titanium dioxide particles dispersed in the solution, the anatase titanium dioxide particles having an average particle size between 5 nm and 10 nm and having a weight percentage in the nano-boron textile coating between 0.05 wt % and 0.2 wt %.

In yet another embodiment, a textile including an applied nano-boron textile coating as described above is disclosed.

Also described herein is a process for preparing the nano-boron textile coatings of the present disclosure. In one embodiment, a process for preparing a textile coating is comprised of: providing a solution of silicon, a dispersant, a softener, and acetic acid mixed in water; and dispersing a plurality of nano-boron particles in the solution.

Beneficially, the nano-boron textile coating and process for preparing the textile coating as disclosed herein have resulted in a textile coating that enhances resistance to bacterial or fungal growth and enhancement in photocatalytic activity through boron serving as a p-type dopant. With the addition of nano-boron as a dopant photocatalyst, the nano-boron textile coating further enhances resistance to both bacteria or fungi growth and helps remove stain formation. The nano-boron textile coatings are comprised of readily available materials and are further capable of enhancing the basic photocatalytic activity of the most commonly utilized titania particles. Hence, photocatalytic activity enhancement through nano-boron addition is advantageous against both stain formation and bacteria growth.

### BRIEF DESCRIPTION OF THE DRAWINGS

These and other features, aspects, and advantages of the present invention will become better understood when the following detailed description is read with reference to the accompanying drawings in which like characters represent like parts throughout the drawings. Unless noted, the drawings may not be drawn to scale.

FIG. 1 illustrates a process for preparing a nano-boron textile coating in accordance with an embodiment of the present disclosure.

FIG. 2 illustrates a process for preparing another nano-boron textile coating in accordance with an embodiment of the present disclosure.

FIG. 3 shows a graph comparing wettability responses of nano-boron textile coatings by measured contact angles in accordance with an embodiment of the present disclosure.

FIG. 4 shows a graph of UV absorbance of differently finished textile samples in accordance with an embodiment of the present disclosure.

FIG. 5 shows stain behavior over time formed on differently finished textiles in accordance with an embodiment of the present disclosure.

### DETAILED DESCRIPTION

### Nano-Boron Textile Coatings

In accordance with an embodiment as described herein, a nano-boron textile coating is comprised of: a solution including silicon, a dispersant, a softener, and acetic acid mixed in water; and a plurality of nano-boron particles dispersed in the solution.

In accordance with further embodiments, the nano-boron textile coating as described above may have any one of the following, which may be alternatives that can be combined in various applicable and functional combinations: the nano-boron particles have an average particle size between 50 nm and 100 nm; a weight percentage of nano-boron particles in the nano-boron textile coating is between 0.001 wt % and 0.2 wt %, and a weight percentage of the solution in the nano-boron textile coating is between 1 wt % and 4 wt %; 0.2 grams of nano-boron particles are dispersed in 100 milliliters of the solution; the nano-boron particles have a zeta-potential between −33 mV and −35 mV in DI water and +14 mV and +18 mV in the finishing solution; the solution has a total weight percentage of 2.7 wt % in deionized water, the solution having a pH of 3.5; the solution has an initial pH between 3 and 4, and the nano-boron textile coating has a pH between 5 and 7; a plurality of titanium oxide particles are dispersed in the solution; a weight percentage of titanium oxide particles in the nano-boron textile coating is between 0.05 wt % and 0.2 wt %; the titanium oxide particles are anatase titanium dioxide particles; the titanium oxide particles have an average particle size between 5 nm and 10 nm; the silicon is a surface modified silicon oxide nanoparticle having an average particle size between 2.7 μm and 3.0 μm; and any applicable combination thereof.

According to another embodiment as described in the present disclosure, a nano-boron textile coating is comprised of: a hydrophobic solution including a surface modified silicon oxide nanoparticle having an average particle size between 2.7 μm and 3.0 μm, a dispersant, a softener, and acetic acid mixed in water, the solution having a weight percentage in the nano-boron textile coating between 1 wt % and 4 wt %; a plurality of nano-boron particles dispersed in the solution, the nano-boron particles having an average particle size between 50 nm and 100 nm and having a weight percentage in the nano-boron textile coating between 0.001 wt % and 0.2 wt %; and a plurality of anatase titanium dioxide particles dispersed in the solution, the anatase titanium dioxide particles having an average particle size between 5 nm and 10 nm and having a weight percentage in the nano-boron textile coating between 0.05 wt % and 0.2 wt %.

In accordance with further embodiments, the nano-boron textile coating as described above may have any one of the following, which may be alternatives that can be combined in various applicable and functional combinations: 0.2 grams of nano-boron particles are dispersed in 100 milliliters of the solution; the nano-boron particles have a zeta-potential between −33 mV and −35 mV in DI water and between +14 mV and +18 mV in solution; the solution has a total weight percentage of 2.7 wt % in deionized water, the solution having a pH of 3.5; the solution has an initial pH between 3 and 4, and the nano-boron textile coating has a pH between 5 and 7; and any applicable combination thereof.

### Textiles and Garments

Another embodiment as described in the present disclosure pertains to an antimicrobial textile including a nano-boron textile coating, according to any one of the descriptions above, applied onto a surface of the textile. In accordance with another embodiment, the antimicrobial textile may have a surface charge at a pH 3.5 which is a greater negative value than −3.6.

It is noted that the various components that describe the nano-boron textile coating disclosed above can be alternatives which may be combined in various applicable and operable combinations within the scope of the present invention.

### General Preparation Process

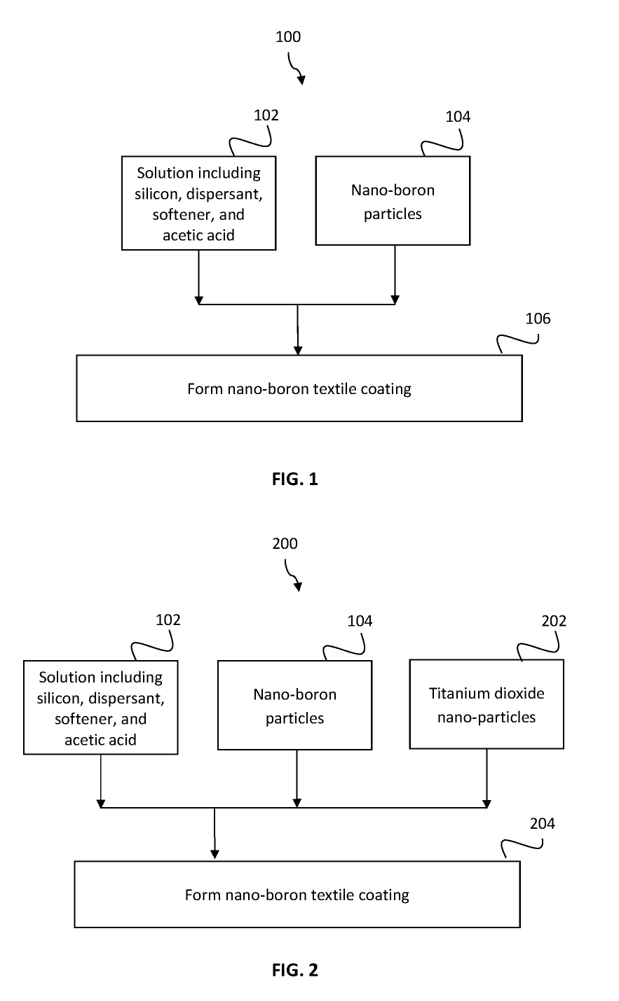

Referring now to FIGS. 1 and 2, processes for preparing the nano-boron textile coatings as described herein are provided in accordance with embodiments of the present disclosure. Nano-boron textile coatings are prepared which are stable as a solution. The prepared nano-boron textile coating is then applied to a textile surface to maintain durability as a coating.

FIG. 1 illustrates a method 100 for preparing a nano-boron textile coating in accordance with an embodiment of the present disclosure. Method 100 includes providing a solution of silicon, a dispersant, a softener, and acetic acid mixed in water at step 102. Method 100 further includes providing a plurality of nano-boron particles at step 104. The plurality of nano-boron particles are dispersed in the solution of silicon, a dispersant, a softener, and acetic acid at step 106, to thereby form a nano-boron textile coating in accordance with an embodiment of the present disclosure. The plurality of nano-boron particles may be substantially pure boron or a combination of substantially pure boron and boron compounds.

FIG. 2 illustrates a method 200 for preparing a nano-boron textile coating in accordance with another embodiment of the present disclosure. Method 200 includes providing a solution of silicon, a dispersant, a softener, and acetic acid mixed in water at step 102. Method 200 further includes providing a plurality of nano-boron particles at step 104, and providing a plurality of titanium oxide particles at step 202. The plurality of nano-boron particles and the plurality of titanium oxide particles are dispersed in the solution of silicon, a dispersant, a softener, and acetic acid at step 204, to thereby form a nano-boron textile coating in accordance with another embodiment of the present disclosure. As above, the plurality of nano-boron particles may be substantially pure boron or a combination of substantially pure boron and boron compounds.

In accordance with further embodiments, the methods of preparing nano-boron textile coatings as described above may include any one of the following, which may be alternatives that can be combined in various applicable and functional combinations: the silicon is provided to include surface modified silicon oxide nanoparticles having an average particle size between 2.7 μm and 3.0 μm; the nano-boron particles are provided to have an average particle size between 50 nm and 100 nm; the nano-boron particles are dispersed to have a weight percentage of nano-boron particles in the nano-boron textile coating between 0.001 wt % and 0.2 wt %, and the solution is provided to have a weight percentage of the solution in the nano-boron textile coating between 1 wt % and 4 wt %; 0.2 grams of nano-boron particles are dispersed in 100 milliliters of the solution; the nano-boron particles are provided to have a zeta-potential between −33 mV and −35 mV in DI water and between +14 mV and +18 mV in the solution; the solution is provided to have a total weight percentage of 2.7 wt % in deionized water to a pH of 3.5; the solution is provided to have an initial pH between 3 and 4, and the nano-boron textile coating is prepared to have a pH between 5 and 7; the plurality of nano-boron particles are dispersed in the solution by sonication; dispersing a plurality of titanium oxide particles in the solution; the titanium oxide particles are dispersed to have a weight percentage of titanium oxide particles in the nano-boron textile coating between 0.05 wt % and 0.2 wt %; the titanium oxide particles are anatase titanium dioxide particles; the titanium oxide particles are provided to have an average particle size between 5 nm and 10 nm; applying the mixture to a textile is by immersion, transfer coating, foam coating, spraying, or other wet application technique; drying the applied nano-boron textile coating by ambient air or heat from a heat source; and any applicable combination thereof.

Advantageously, the nano-boron textile coatings of the present disclosure provide an antimicrobial effect with a high killing rate on both Gram negative and Gram positive bacteria. The killing rate is particularly effective on Gram negative bacteria (e.g., E. coli) when applied on textiles under ambient conditions, such as those in a typical hospital scenario.

Furthermore, the nano-boron textile coatings of the present disclosure are capable of enhancing the basic photocatalytic activity of the most commonly utilized titania particles, which are effective within the UV radiation to visible light ranges. The present textiles, with applied nano-boron textile coatings including titanium oxide particles, are “self-cleanable” in the interior environments (in other words, where there is no sun-light) such as hospitals, schools, primary care facilities, and the like.

### Examples of Nano-Boron Textile Coatings and Methods

### Example 1: Preparation of Nano-Boron Coatings

Nanometer-sized particles of boron (nano-boron) with 99.7% purity and reported average particle size of 50 nm were obtained from NaBond Technologies Corporation, China. In order to apply the nano-boron on the textile samples, solutions of the nano-boron powder were prepared at 0.002, 0.02 and 0.2 wt % (g/100 ml) concentrations by dispersing the particles in deionized (DI) water as well as in a textile finishing solution. A textile finishing solution was prepared by using Setasif® for silicon, Serisoft® for softener, Ekoline® for dispersant, and acetic acid with a 2.7 total wt % in composition of DI water and measured pH of 3.52. In order to homogeneously disperse the nano-boron particles, the suspensions were prepared at pH 6 and continuously stirred for 15 minutes. The prepared suspensions were tested for static stability, particle size and zeta potential after their uniform dispersion in DI water and the finishing solution.

Nano-boron particle solutions prepared in DI water and the finishing solution at 0.002, 0.02 and 0.2 wt % concentrations were transferred into 100 ml graduated cylinders in order to observe their settling behaviour as a function of time. The suspension prepared in both DI water and the finishing solution stayed stable in the 24-hr time frame after preparation. The uniformly dispersed solutions were kept in the graduated cylinders (at room temperature) for an extended timeframe and it was observed that all the samples were stable for more than a week, which shows the applicability of the nano-boron solutions in the textile manufacturing environment.

Particle size measurements were performed using a light scattering technique with a Coulter LS-13 320 Laser Diffraction Particle Size Analyzer (Beckman Coulter ALM-aqueous Liquid Module). Both DI water and the finishing solution were used as backgrounds at pH 6 for the nano-boron suspensions in the DI water and finishing solution, respectively. Thus, contributions from other additives (such as silicon) in the finish solution in the size measurements of nano-boron were avoided. The polarized intensity differential scattering (PIDS) setting was increased to 50% by adding the nano-boron solution drop by drop to the background solution.

Zeta potential of the nano-boron suspensions were measured by using a Malvern Nano ZS Analyzer in DI water and in textile finishing solution at pH 3.52 to determine the total electrical charge potential surrounding the particles to enhance their stability. The zeta-potential measurements were carried out in DI water and finishing solution at pH 6. Nano-boron particles dispersed in the DI water had a negative surface charge (−33 mV) while the ones prepared in the finishing solution had a positive surface charge (+16 mV). This observation verifies the interaction of the nano-boron particles with the additions of the finishing solution resulting in the change of the shapes of the particles.

In addition, a 3-μl droplet of the nano-boron suspensions prepared in DI water and the finishing solution were deposited on freshly cleaved mica surfaces, spread and dried in the oven at 37° C., after which a micrograph was taken using a Nanomagnetics Instruments atomic force microscope (AFM), in tapping mode as a function of nano-boron particle concentration. Some agglomeration was observed in the nano-boron solution prepared in DI water, which was shown by irregular cross sections taken on random points. A flaky nature of the nano-boron particles was also observed. The cross-section analyses taken on the sample prepared in the finishing solution on the other hand, illustrated more rounded images that could be attributed to the presence of the silicon particles surrounding the nano-boron particles that tend to be round in shape.

### Example 2: Application of Nano-Boron Coatings on Textile Samples

Solutions of boron nanoparticles (nano-boron textile coatings) were coated by dip-coating on a textile sample having a 47% polyester, 47% viscose and 6% spandex fiber composition. It is noted that other coating application methods may be used to coat a nano-boron textile coating onto a textile, including but not limited to immersion, transfer coating, foam coating, spraying, or other wet application technique.

Color fastness tests were conducted according to ISO 105-A05 standards. In this method, a single layer of untreated or treated textile sample was fitted in the instrument's holder on the back of an opaque white material. A reference was prepared using the same thicknesses as that of the test specimen. The reference sample was then mounted on the holder to measure its color values with a spectrophotometer and compared to measured color values of the test sample.

The textile was chosen to be a dark color to test for color fastness or maintainability of the original color after the application of the nano-boron powder. As the nano-boron particles have a dark color, a black colored textile was selected for the treatment in one example. The physical tests did not show any changes as compared to the control textiles. The color fastness analyses conducted in 50° C. wash fastness, in water, alkali and acid media, and on 0.002 wt % nano-boron in finishing solution also remained unchanged. The textile coated with 0.2 gram boron in 100 ml finishing solution showed a very slight change in color, but this sample has also passed the color fastness test.

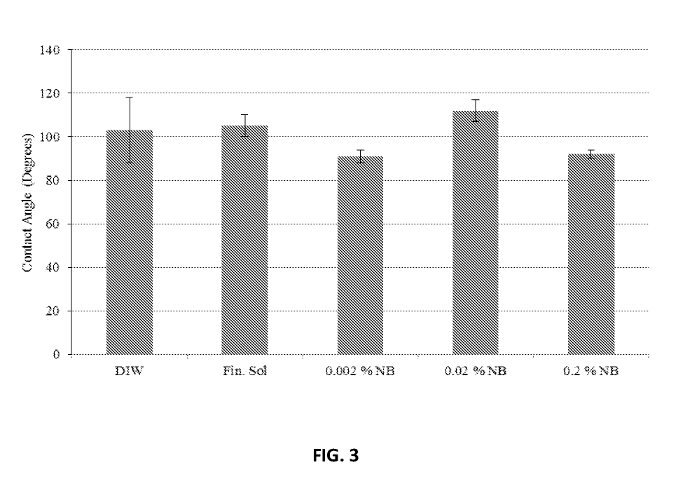

Wettability measurements were performed on the uncoated control and coated textiles using sessile-drop contact angle measurements with a KSV ATTENSION Theta Lite Optic Contact Angle Goniometer. Three readings were taken for each sample as a function of time intervals of 10 seconds up to 200 seconds. The change in the textile samples treated with different concentrations of nano-boron solutions were also characterized for their wettability responses by measuring water contact angles. FIG. 3 shows a graph comparing the wettability responses on the control textile (DIW), textile treated with only finishing solution (Fin. Sol.), and the textiles coated with nano-boron in finishing solution at three different concentrations (0.002% NB, 0.02% NB, 0.2% NB). The sample treated with 0.02% wt % nano-boron in finishing solution tended to be the most hydrophobic.

Electrokinetic properties (e.g., surface charges) were measured using streaming potential measurements with a SurPASS Electrokinetic Analyzer (Anton Paar GmbH, Austria). Textiles samples were inserted in a cylindrical cell with the help of supporting discs that had holes in them to allow the flow of electrolyte between electrodes through the textile sample. The measuring electrodes were attached to movable pistons which allowed the distance between the electrodes to be varied and the density of a textile sample to be adjusted. The background electrolyte which was prepared for measurements contained 1 mM KCL solution, and 0.05M HCl solution was added for the pH titration as a function of time.

Table 1 below summarizes the isoelectric points (IEP) and surface charge measurements at a pH of 3.52 of the textiles which were treated with 0.002 wt %, 0.02 wt %, and 0.2 wt % of nano-boron in the finishing solution. IEPs of textiles treated with increasing concentrations of nano-boron shifted to lower pH values becoming more acidic. Furthermore the surface charge measurements taken at the pH of finishing solution (pH 3.52) also indicated increasing negative values at higher concentrations of the nano-boron particle treated textiles. This is indicative that the addition of nano-boron changes the surface nature of the textiles, which may be the reason why the textile gains enhanced antibacterial and photocatalytic properties.

TABLE 1

| | | SURFACE |
|---|---|---|
| | ISOELECTRIC | CHARGE |
| SAMPLE TREATMENT | POINT | (at pH 3.52) |
| Finishing solution only | 3.1 | −3.6 |
| 0.002 wt. % NB in finishing solution | 3.1 | −3.7 |
| 0.020 wt. % NB in finishing solution | 2.8 | −6.2 |
| 0.200 wt. % NB in finishing solution | 2.5 | −8.5 |

Surface morphology of the coated textiles was measured using optical microscopy and atomic force microscopy (AFM). Typical field of view in AFM was 10×10 μm². A Nanomagnetics Instruments EZ-AFM was used as a special tool designed for taking high resolution AFM micrographs on soft surfaces such as textiles. It was observed that nano-boron particles interact with silicon particles within the finishing solution to then coat the textile.

### Example 3: Photocatalytic Evaluations on Nano-Boron Coated Textiles

Conventional anatase TiO₂ powder was obtained from Nanografi Corporation, Turkey. These powders had a 7.3 nm mean particle size. Untreated polyester fabrics (100% purity, 10×10 cm² size) were immersed in aqueous solutions of TiO₂ at 0.1 wt % concentration and 0.02 wt % nano-boron. Coating applications were performed using sonication for 15 minutes in 250 ml aqueous solutions of nanoparticles of both nano-boron and titania, individually and the combination. Stain decomposing studies were performed under UV light (540 nm).

Uncoated polyester fabrics and those coated with pure anatase titania, pure nano-boron and the combination of titania and nano-boron were immersed into 100 ml (5 mg/L) methylene blue solution. The samples were then exposed to UV light for 2 hours. The rate of photocatalytic bleaching of methylene blue in aqueous solution was measured by UV/Vis spectrophotometry using a TG80 UV/VIS Spectrometer (PG Inst. Ltd, UK) at 596 nm with 30 minute time intervals for six measurements.

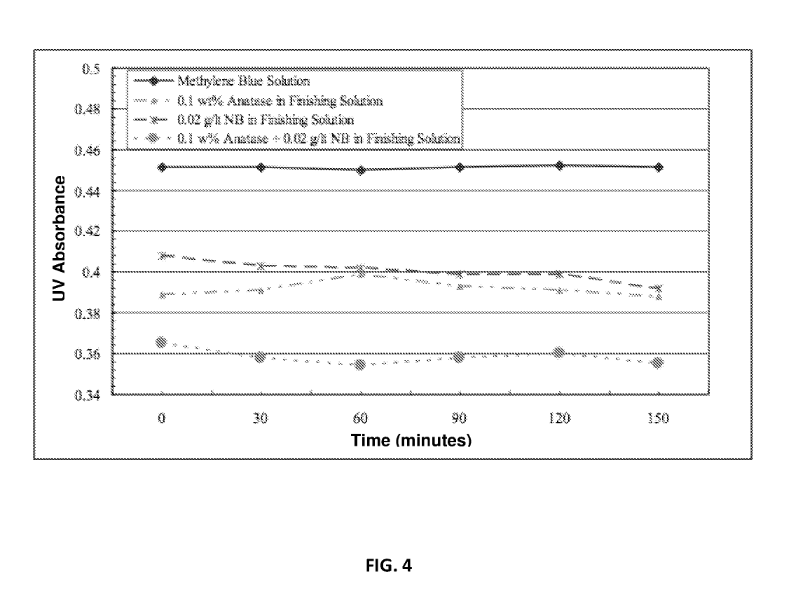

FIG. 4 shows a graph of UV absorbance of textiles coated with methylene blue (diamond), textiles coated with 0.1 wt % anatase in finishing solution (triangle), textiles coated with 0.02 wt % nano-boron in finishing solution (X), and textiles coated with 0.02 wt % nano-boron+0.1 wt % anatase in textile finishing solution (circle). The decrease in the absorbance (ratio of the amount of light that passes through a solution compared to the amount of light that is passed into it) indicates the increase in the transmittance through the solution. As the transmittance of the solution increases, an increase in photocatalytic activity provides for increased cleaning of the methylene blue solution. Thus, FIG. 4 illustrates the improvement in the UV absorbance (i.e., increased transmittance and increased photocatalytic activity) on the textile samples coated by 0.02 wt % nano-boron particles in addition to 0.1 wt % anatase in finishing solution. Furthermore, the stain bleaching tests conducted with the methylene blue stain formation on the textiles with 0.02 wt % nano-boron and the textiles with 0.1 wt % anatase were observed to be less effective after 24 hours of UV treatment as compared to the textiles treated with the 0.02 wt % nano-boron+0.1 wt % anatase.

The addition of nano-boron improved the photocatalytic activity of the textile which, although the present invention and disclosure is not limited by this theory, is believed to be due to the enhanced electron mobility in the presence of the nano-boron. TiO₂ nanoparticles offer various applications as surfaces for self-cleaning, water and air purification, anti-fogging, and photovoltaics. Photocatalytic degradation on TiO₂ of many substances such as formaldehyde, 3-amino-2-chloropyridine, acid orange, phenol and methylene blue in solution phase has been studied and proven to be effective. Photocatalytic degradation of molecules due to light illumination of a photocatalyst is based on interaction with electrons and molecules adsorbed on the surface. Photocatalytic activity of unmodified TiO₂ nanoparticles occur in a wide band gap (anatase 3.2 eV, rutile 3.0 eV) and can be utilized only under UV light. An improvement of the TiO₂ catalysts photoactivity can be achieved by enhancement of the separation of photo generated electron-hole pairs and sensitizing titania for visible-light activity by doping with metal ions.

### Example 4: Further Photocatalytic Evaluations on Nano-Boron Coated Textiles

Further stain degradation studies were conducted by deliberately decorating textiles with drips from a Pasteur pipette. The drip was made with a 0.02 M methylene blue solution. After the staining, the textile samples were exposed to UV light (340 nm) for 24 hours to observe bleaching of the stain. Photographs were taken just after staining and after the 24 hour UV treatment.

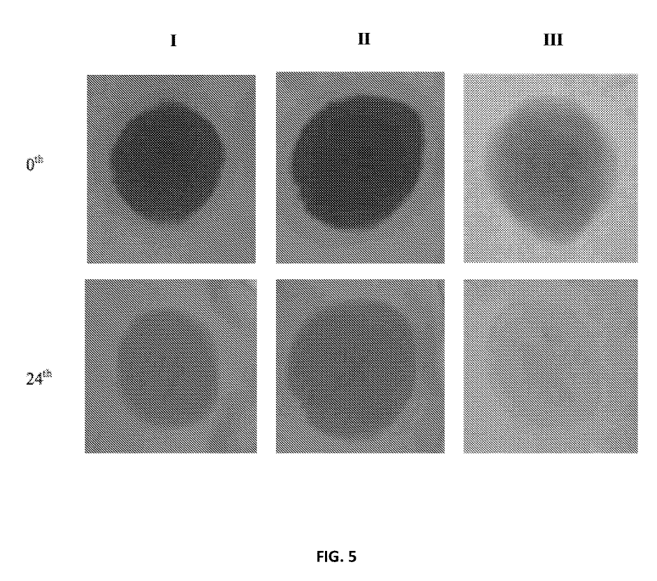

FIG. 5 compares the stains formed on the textiles treated with the three conditions of Example 3: (I) 0.02 wt % nano-boron in DI water; (II) 0.02 wt % nano-boron+0.1 wt % anatase in DI water; and (III) 0.02 wt % nano-boron+0.1 wt % anatase in finishing solution, immediately after the stain was induced (Row 0^{th}) and after the 24th hour of UV treatment (Row 24^{th}). Hence it can be concluded that the nano-boron addition on the textile treatment can both help in anti-microbial activity against MRSA type species in addition to the self-cleaning ability by improved photocatalytic response.

### Example 5: Antibacterial/Antimicrobial Evaluations on Nano-Boron Coated Textiles

Antibacterial properties of boron coated textiles were tested using bacteria cell culture. A total volume of 500-μl of culture (200-μl of culture at 10⁵ cfu/ml+300 μl of 0.85% NaCl) was used. Textile samples (2×2 cm²) were incubated with cultures for 60 minutes under ambient conditions (room temperature was 20° C.). The inoculum was then plated on MHA agar plates under two different dilutions in triplicates in order to obtain statistically-valid results.

Testing on antibacterial activity of the nano-boron treated textiles against E. coli and MRSA showed that addition of nano-boron in finishing solution killed the MRSA effectively. The most effective antibacterial activity was achieved at 0.02 wt. % nano-boron particle treated textile samples in alignment with the highest hydrophobicity observations. The antibacterial activity of the nano-boron coating did not require any additional stimulation in the presence of MRSA.

Thus, the present disclosure of nano-boron textile coatings advantageously utilize nano-boron particles as a textile finish treatment to prevent bacterial activity either solely or through photocatalytic enhancers, which are used for the prevention of fabric stains and microbes. The incorporation of nano-boron in finishing solution on the textile surfaces made the surfaces more hydrophobic without substantially changing physical color fastness properties. Photocatalytic activity enhancement was observed on the textiles treated with nano-boron with standard anatase nanoparticles. Nano-boron particles were also observed to limit bacteria growth without the need for external stimuli to initiate antibacterial action against MRSA type bacteria.

### Branched Silica

In one embodiment, the silicon used in the nano-boron textile coatings as described above includes surface modified silicon oxide nanoparticles or “branched silica” nanoparticles. Such surface modified silicon oxide nanoparticles improve coating stability, coating attachment to a textile surface (as a binder), photocatalytic activity of the textile, coating stain resistance, and/or coating durability of the nano-boron on the textile over time (for example through textile wash cycles).

The surface modified silicon oxide may be prepared, in one example, by using tetraethyl orthosilicate (TEOS) as a precursor and 2-(2-methoxyethoxy)ethanol (DEGME) added as the surface modifier to avoid formation of agglomeration of SiO2 nanoparticles. The modified silicon oxide may be synthesized by providing ethanol mixed with deionized water, mixing in NH₄OH, mixing in TEOS and DEGME, adjusting pH to 7, and drying at 100° C. The synthesized surface modified silicon oxide particle size had a mean size between 2.7 μm and 3.0 μm.

The foregoing examples have been provided merely for the purpose of explanation and are in no way to be construed as limiting of the present invention. While the present invention has been disclosed with reference to embodiments, the words used herein are intended to be words of description and illustration, rather than words of limitation. While the present invention has been described with reference to particular materials and embodiments, the present invention is not intended to be limited to the particulars disclosed herein. For example, the various components that make up the nano-boron textile coating or the various components that describe the coating, textile, or preparation methods disclosed above can be alternatives which may be combined in various applicable and functioning combinations within the scope of the present invention. Rather, the present invention extends to all functionally equivalent structures, materials, and uses, such as are within the scope of the appended claims. Changes may be made, within the purview of the appended claims, as presently stated and as may be amended, without departing from the scope and spirit of the present invention. All terms used in this disclosure should be interpreted in the broadest possible manner consistent with the context.

1. A nano-boron textile coating, comprising:
a solution including surface modified silicon oxide nanoparticles, a dispersant, a softener, and acetic acid mixed in water; and
nano-boron particles dispersed in the solution.

2. The nano-boron textile coating according to claim 1, wherein the nano-boron particles have an average particle size between 50 nm and 100 nm.

3. The nano-boron textile coating according to claim 1, wherein a weight percentage of nano-boron particles in the nano-boron textile coating is between 0.001 wt % and 0.2 wt %, and wherein a weight percentage of the solution in the nano-boron textile coating is between 1 wt % and 4 wt %.

4. The nano-boron textile coating according to claim 1, wherein 0.2 grams of nano-boron particles are dispersed in 100 milliliters of the solution.

5. The nano-boron textile coating according to claim 1, wherein the nano-boron particles have a zeta-potential between −33 mV and −35 mV in DI water and between +14 mV and +18 mV in the solution.

6. The nano-boron textile coating according to claim 1, wherein the solution has a total weight percentage of 2.7 wt % in deionized water, the solution having a pH of 3.5.

7. The nano-boron textile coating according to claim 1, wherein the solution has an initial pH between 3 and 4, and wherein the nano-boron textile coating has a pH between 5 and 7.

8. The nano-boron textile coating according to claim 1, wherein the surface modified silicon oxide nanoparticles have an average particle size between 2.7 μm and 3.0 μm.

9. (canceled)

10. The nano-boron textile coating according to claim 1, further comprising a plurality of titanium oxide particles dispersed in the solution, wherein a weight percentage of titanium oxide particles in the nano-boron textile coating is between 0.05 wt % and 0.2 wt %.

11. The nano-boron textile coating according to claim 10, wherein the titanium oxide particles are anatase titanium dioxide particles having an average particle size between 5 nm and 10 nm.

12. The nano-boron textile coating according to claim 10, further comprising a nano-boron compound including a compound selected from the group consisting of nano-boron oxides, nano-boron nitrides, nano-boron carbonates, and a combination thereof.

13. A nano-boron textile coating, comprising:
a hydrophobic solution including surface modified silicon oxide nanoparticles having an average particle size between 2.7 μm and 3.0 μm, a dispersant, a softener, and acetic acid mixed in water, the solution having a weight percentage in the nano-boron textile coating between 2.7 wt % and 3.0 wt %;
a plurality of nano-boron particles dispersed in the solution, the nano-boron particles having an average particle size between 50 nm and 100 nm and having a weight percentage in the nano-boron textile coating between 0.001 wt % and 0.2 wt %; and
a plurality of anatase titanium dioxide particles dispersed in the solution, the anatase titanium dioxide particles having an average particle size between 5 nm and 10 nm and having a weight percentage in the nano-boron textile coating between 0.05 wt % and 0.2 wt %.

14. The nano-boron textile coating according to claim 13, wherein 0.2 grams of nano-boron particles are dispersed in 100 milliliters of the solution.

15. (canceled)

16. The nano-boron textile coating according to claim 13, wherein the solution has a total weight percentage of 2.7 wt % in deionized water, the solution having a pH of 3.5.

17. (canceled)

18. (canceled)

19. (canceled)

20. A process for preparing and applying a nano-boron textile coating, the process comprising:
providing a solution of surface modified silicon oxide nanoparticles, a dispersant, a softener, and acetic acid mixed in water; and
dispersing a plurality of nano-boron particles in the solution.

21. The process according to claim 20, wherein surface modified silicon oxide nanoparticles are provided to have an average particle size between 2.7 μm and 3.0 μm, and wherein the nano-boron particles are provided to have an average particle size between 50 nm and 100 nm.

22. The process according to claim 20, wherein the nano-boron particles are dispersed to have a weight percentage of nano-boron particles in the nano-boron textile coating between 0.001 wt % and 0.2 wt %, and wherein the solution is provided to have a weight percentage of the solution in the nano-boron textile coating between 1 wt % and 4 wt %.

23. (canceled)

24. The process according to claim 20, wherein the solution is provided to have an initial pH between 3 and 4, and wherein the nano-boron textile coating is prepared to have a pH between 5 and 7.

25. (canceled)

26. The process according to claim 20, further comprising dispersing a plurality of titanium oxide particles in the solution.

27. The process according to claim 15, wherein the titanium oxide particles are dispersed to have a weight percentage of titanium oxide particles in the nano-boron textile coating between 0.05 wt % and 0.2 wt %, and wherein the titanium oxide particles are anatase titanium dioxide particles having an average particle size between 5 nm and 10 nm.

28. (canceled)

29. (canceled)

30. (canceled)
